(19) United States
(12) Patent Application Publication
(10) Pub. No.: US 2018/0033051 A1
(43) Pub. Date: Feb. 1, 2018

(54) INTEREST BASED DELIVERY SYSTEM AND METHOD IN A CONTENT RECOMMENDATION NETWORK

(71) Applicant: RevContent, LLC, Sarasota, FL (US)

(72) Inventors: Chris Maynard, Sarasota, FL (US); John Daniel Lemp, Sarasota, FL (US); Aziz Hussein, Sarasota, FL (US); Julien Chinapen, Sarasota, FL (US)

(73) Assignee: RevContent LLC, Sarasota, FL (US)

(21) Appl. No.: 15/662,088

(22) Filed: Jul. 27, 2017

Related U.S. Application Data
(60) Provisional application No. 62/367,983, filed on Jul. 28, 2016.

(51) Int. Cl. G06Q 30/02; G06F 17/30

(52) U.S. Cl. CPC G06Q 30/0269; G06F 17/30876

(57) ABSTRACT

Aspects of the present disclosure are presented for a third party content recommendation platform to tailor advertisements presented to a web user based on the web user's stated and specific input about what types of topics the user is interested in. In some embodiments, widgets are uploaded and presented through publisher content, such as a publisher website or email newsletter. Widgets according to aspects of the present disclosure may include instructions for redirecting the web user to an interface that allows the user to specify what types of topics said user would like to see in later advertisements. This input, coupled with additional data, according to some embodiments, may be processed by the third party content recommendation platform to provide more desired advertising content to the web user.

### CROSS REFERENCE TO RELATED APPLICATION

This application claims the benefit of U.S. Provisional Application 62/367,983, filed Jul. 28, 2016, and titled “INTEREST BASED DELIVERY SYSTEM AND METHOD IN A CONTENT RECOMMENDATION NETWORK,” the disclosure of which is hereby incorporated herein by reference in its entirety and for all purposes.

### TECHNICAL FIELD

The subject matter disclosed herein generally relates to processing data. In some embodiments, the present disclosures relate to methods and apparatuses for providing an interest-based delivery system and method in a content recommendation network.

### BACKGROUND

Left with content recommendations based upon machine learning models, retargeting and or other methods interest based delivery is a new model for content recommendation by asking the user to provide input to the model rather than basing the recommendation on other signals.

There is currently not a way for users to control their recommendations based on their stated interests, and the present disclosures solve this problem by allowing users to explicitly tell the network their interests.

### BRIEF SUMMARY

Aspects of the present disclosure are presented for a third party content recommendation network platform in e-commerce to enable web users who view publisher websites that use the third party content recommendation network platform for advertisements to specify, with more control, what types of ads said web users would like to view.

In some embodiments, a method is presented. The method may include: transmitting, by a processor of a third party content recommendation platform, an interest-based widget to a publisher content site associated with the third party content recommendation platform, the interest-based widget comprising: information associated with an advertisement of an advertiser, a link to an advertisement site associated with the advertisement, and a link to a user interest interface; causing display of the user interest interface, based on receiving a user input of a user of the publisher content site, through the interest-based widget embedded in the publisher content site; receiving, by the processor, a user-selected input specifying one or more topics of advertisements the user prefers to view, through the user interest interface; recording, by the processor, the user-selected input; transmitting a second widget to a second publisher content site that incorporates the user-selected input; and causing display of a second advertisement associated with the second widget that is based at least in part on the user-selected input.

In some embodiments, the method further includes redirecting the user to an originally selected advertisement site of the interest-based widget.

In some embodiments, the method further includes developing a user graph comprising a determination of the user's advertising interests, based at least in part on the user-selected input.

In some embodiments of the method, transmitting the second widget to the second publisher is based on the developed user graph. In some embodiments, developing the user graph comprises developing a fundamental core set of user interests, based on the user-selected input, and developing a time-decay set of user interests that loses weight in determining the interests in the user graph as time passes.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some embodiments.

FIG. 2 illustrates an example process for providing direct user input to influence the selection of advertisements by the content recommendation network, according to some embodiments.

FIG. 3 shows an example graphical interface that may be presented to a user through the widget of the network-based system, according to some embodiments.

FIG. 4 shows an example interface for use by a publisher who is a subscriber of the network-based system, to enable the user-based interest functionality of the present disclosures, according to some embodiments.

FIG. 5 is a sample advertisement that may prompt a user to interface with the network-based system, according to some embodiments.

FIG. 6 provides an example process for conducting the user-specified advertisement modifications, according to some embodiments.

FIG. 7 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for a third party content recommendation network platform in e-commerce to enable web users who view publisher websites that use the third party content recommendation network platform for advertisements to specify, with more control, what types of ads said web users would like to view. The web users may be retargeted with more pertinent ads based at least in part on their own input, after interfacing with a user interface that provides feedback to the third party content recommendation network.

The third party content recommendation platform may generally help facilitate advertisements, offered by one or more advertising companies (e.g., a specific company advertising its products, or an e-marketing company advertising on behalf of one or more companies offering products) to be displayed in one or more publishers web properties (e.g., websites displaying content, such as CNN.com, blogs, e-commerce websites, etc.). The third party content recommendation platform may allow a publisher to place widgets onto its websites, wherein these widgets may include one or more advertisements, a link leading to an interface with the content recommendation network that receives a user specified interest input, and a forwarding link directing the user to another website associated with the advertisement. The third party content recommendation network platform may record the interest specified by the user for future use, so that later widgets accessed by the user on the same or different publisher websites can incorporate the previously specified user-based interest input to provide more pertinent advertisements to the user.

Conventionally, it is common for content recommendation networks to attempt to provide advertisements that a web user is more likely to be interested in, in order to increase revenue, increase the value of each advertisement, and increase overall benefit to the publishers, advertising companies, and the content recommendation network itself. However, user interests tend to be derived only inferentially, such as based on what a user has previously clicked on, or what the user has searched for and are identifiable in stored cookies. Currently, there does not exist a way for users to more directly control advertisements based on their specified interests.

Aspects of the present disclosure are presented for a third party content recommendation platform to tailor advertisements presented to a web user based on the web user's stated and specific input about what types of topics the user is interested in. In some embodiments, widgets are uploaded and presented through publisher content, such as a publisher website or email newsletter. While conventional widgets typically include an advertisement and a link corresponding to a website associated with the advertisement, widgets according to aspects of the present disclosure also may include instructions for redirecting the web user to an interface that allows the user to specify what types of topics said user would like to see in later advertisements. This input, coupled with additional data, according to some embodiments, may be processed by the third party content recommendation platform to provide more desired advertising content to the web user.

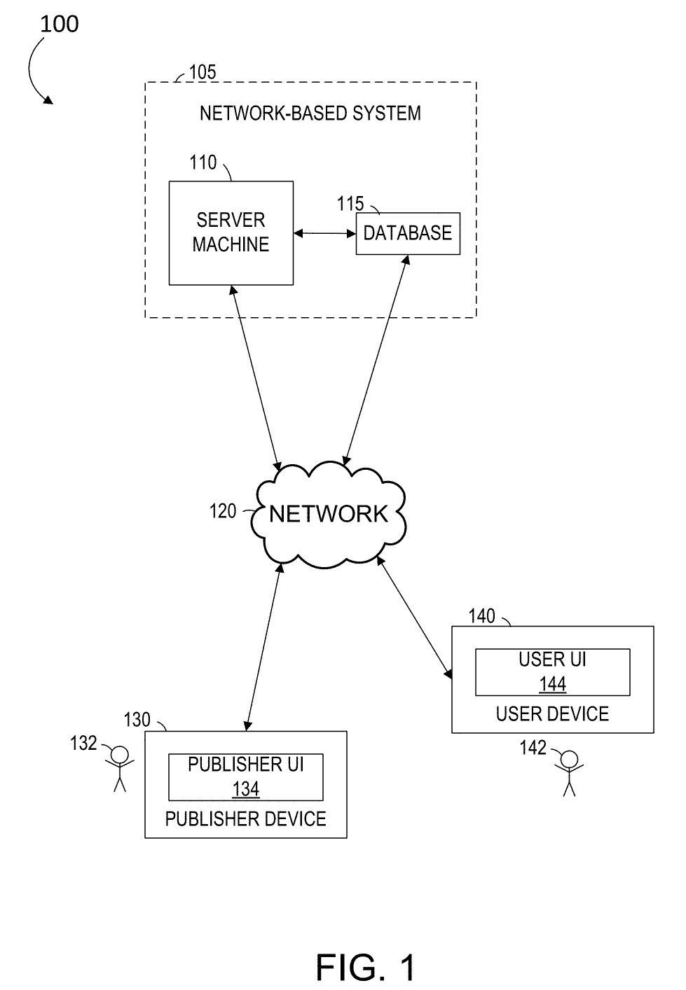

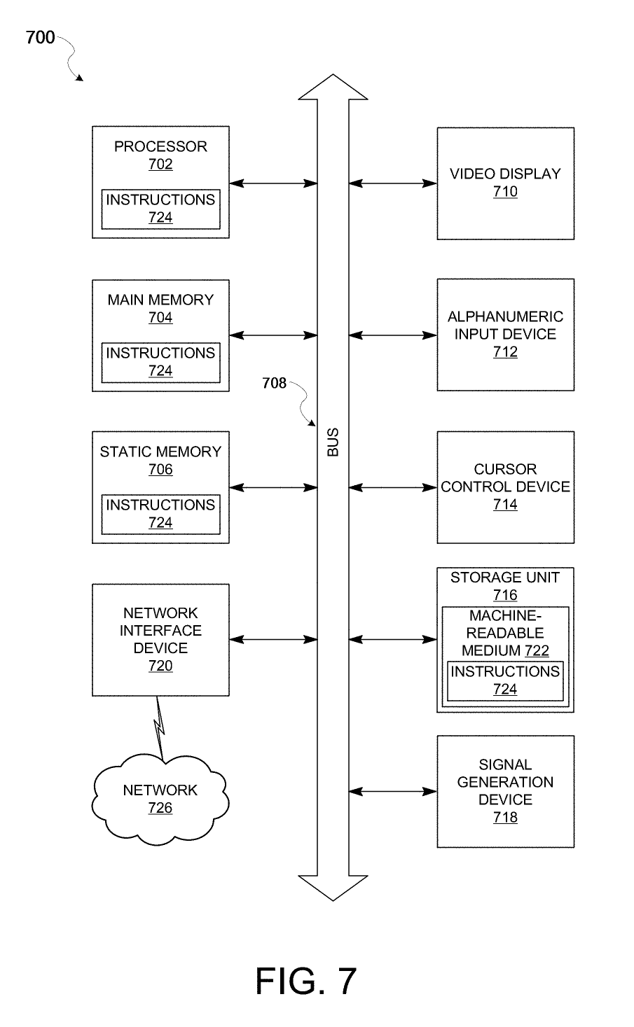

Referring to FIG. 1, a network diagram illustrating an example network environment 100 suitable for performing aspects of the present disclosure is shown, according to some embodiments. The example network environment 100 includes a server machine 110 and a database 115 of a network-based system 105 of a third-party advertising platform, a publisher device 130 for a publisher user 132, and a user device 140 for a user 142 who accesses websites on the Internet, all communicatively coupled to each other via a network 120. The server machine 110 may be implemented by a physical server machine, a virtual server machine, or a combination of the two. may form all or part of a network-based system 105 (e.g., a cloud-based server system configured to provide one or more services to the publisher device 130, user device 140 and publisher device 140). The network-based system 105 may be configured to facilitate advertisement placements by multiple advertisers onto various websites, such as the publisher's 132 websites. In some cases, the publisher 132 also can act as an advertiser, desiring to display advertisements onto other websites in order to direct traffic back to the website(s) of the publisher 132. For purposes of this disclosure, the publisher 132 possesses both one or more websites that displays its own content and advertisements placed by the third party advertisement platform (via the network-based server 105). The server machine 110, the publisher device 130, and the user device 140 may each be implemented in a computer system, in whole or in part, as described below with respect to FIG. 7.

Also shown in FIG. 1 are the publisher user 132 and the website user 142. One or more of the users 132 and 142 may be a human user, a machine user (e.g., a computer configured by a software program to interact with the publisher device 130), or any suitable combination thereof (e.g., a human assisted by a machine or a machine supervised by a human). The publisher user 132 may be associated with the publisher device 130 and may be a user of the publisher device 130. For example, the publisher device 130 may be a desktop computer, a vehicle computer, a tablet computer, a navigational device, a portable media device, a smartphone, or a wearable device (e.g., a smart watch or smart glasses) belonging to the first user 132. Likewise, the website user 142 may be associated with the user device 140. The publisher user 132 may desire to design publisher websites that place advertisements through widgets provided by the network-based system 105 of the content recommendation network. These widgets are controlled by the network-based system 105 and provide advertisements and links to websites associated with the advertisements. The user 142 may be an entity that accesses content on a publisher user 132 website, who may be a target audience of the publisher user 132, due to the user 142 visiting the publisher's website and thereby implying that the user 132 has at least some interest in the publisher's content. The publisher user 132 may be an entity who generates one or more websites that provide content for users 142, and who may generate revenue by allowing advertisers to pay for placing their advertisements on the publisher website(s), where the method of determining what advertisements get displayed on the publisher website may be controlled by the network-based system 105. As previously discussed, the network-based system 105 may be operated by a third-party advertising company that helps facilitate the ad placement of advertisers onto publisher websites.

In some embodiments, the devices 130 and 140 may be configured to display user interfaces that are coupled to the network 120. For example, the publisher device 130 may be configured to display and operate a publisher user interface (UI) 134, and the user device 140 may be configured to display and operate an affiliate UI 144. The Uls 134, and 144 may be configured to receive inputs from a user, such as users 132, and 142, respectively.

Any of the machines, databases 115, publisher device 130, or user device 140 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, and 140. For example, a computer system able to implement any one or more of the methodologies described herein is discussed below with respect to FIG. 7. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the devices 130, and 140). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

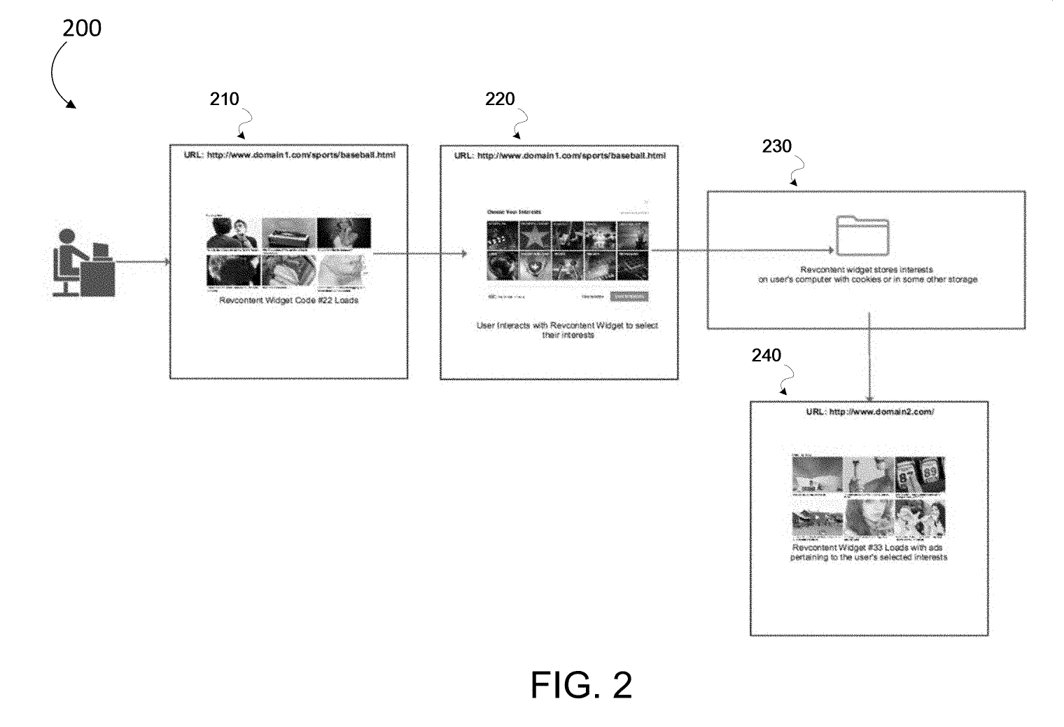

Referring to FIG. 2, flowchart 200 illustrates an example process for providing direct user input to influence the selection of advertisements by the content recommendation network, according to some embodiments. This process begins with a user, such as user 142, visiting a webpage that has a widget of the network-based system 105 in place. Content recommendations are served through the widget as they normally would to this user according to known conventional means. The user may click on an ad banner or other graphic that is included in the widget, at block 210.

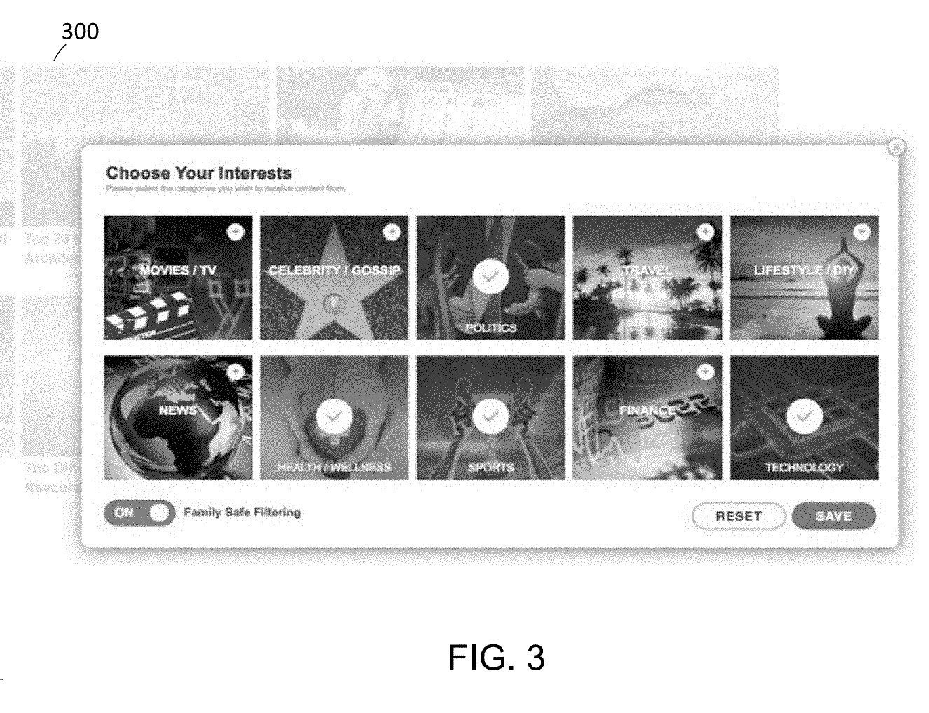

At block 220, the widget will have a link or some way to trigger an event that will show the user 142 a menu of options to decide or input what their interests are. This menu—detailed in FIG. 3—gives the user 142 control of the content recommendation or ads they will see when viewing widgets sourced from the network-based system 105. This event may be triggered due to a secondary link from the initial selection of the widget that generates the interest menu. In other cases, a script associated with the widget in block 210 may run that includes additional instructions to generate and load the interest menu before leading the user 142 to the other advertising content. The interest menu may be loaded from the network-based system 105, or may be embedded as part of the widget when the widget is loaded into the publisher website. In some embodiments, the interest menu may be configured to transmit data, such as the user input, back to the network-based system 105.

At block 230, the network-based system may store the interest input from the user to use at a later time. This input may be stored locally in the user's computer, such as in a cookie, or may be stored in the network-based system 105, such as in the database 115. The input may include information about the type of interest selected by the user, as well as other contextual information, such as from what publisher website the user provided the input, date and time, and other possibly relevant information useful for improving the type of advertisements the user may be interested in viewing.

At block 240, the next time content recommendations serve through the widget for the user on the original website or any other website with a widget provided by the network-based system 105, and as long as the input from the user is saved and available, the content recommendations will be tailored to the user's interests.

Referring to FIG. 3, illustration 300 shows an example graphical interface that may be presented to a user 142 through the widget of the network-based system 105, according to some embodiments. This interface may occur in the process of flowchart 200 at block 220, as described above. As shown, the interface may present the user with a variety of topics, and may request the user to select at least one topic that the user may be interested in receiving more advertisements about. In this example, a user has selected “politics,” “health/wellness,” “sports” and “technology,” among the several options. After making and saving the selections, the widget may proceed to display the intended advertisement originally clicked on by the user 142. Other options may include filtering certain content, either to eliminate whole categories of topics or to filter out more suspect content within each topic. In some embodiments, relative weights may be provided by the user as well, to further inform how interested the user may be in particular topics.

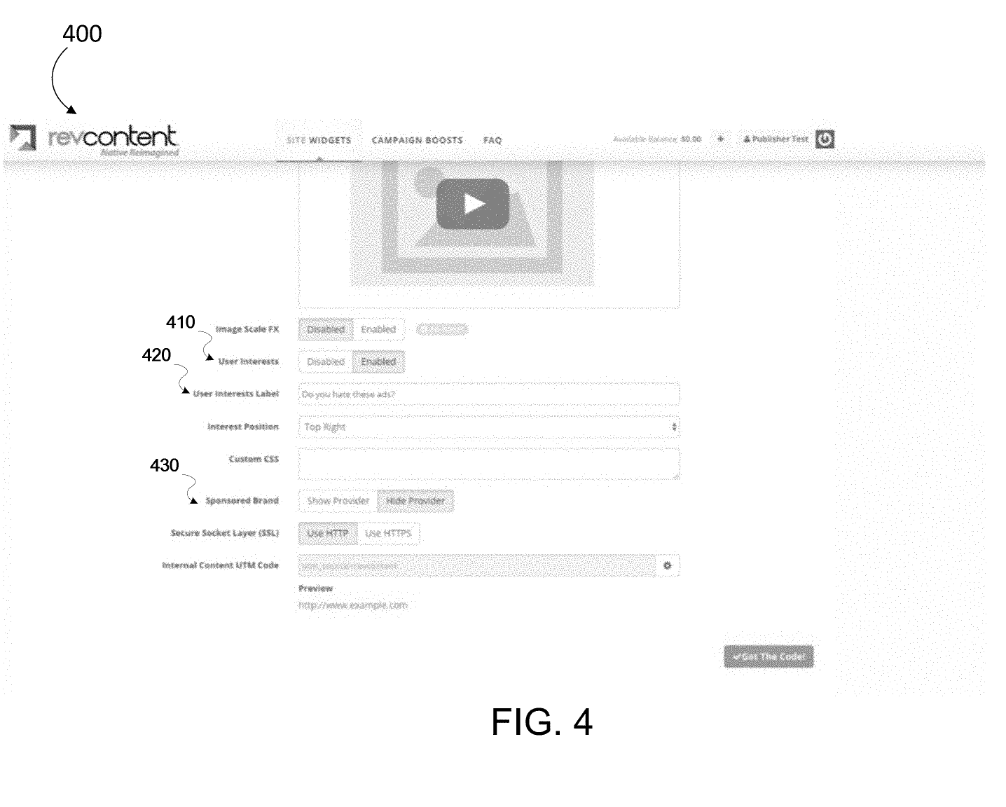

Referring to FIG. 4, illustration 400 shows an example interface for use by a publisher who is a subscriber of the network-based system 105, to enable the user-based interest functionality of the present disclosures, according to some embodiments. The publisher may have access to certain controls in the network-based system 105 to customize how advertisements may be presented and chosen in the content provided by the publisher. In this example interface, the publisher may have certain control to enable the user-specified interest option, by selecting or deselecting the option 410. The publisher may also have control over how to phrase the question prompt to the user, when the user interface (e.g., illustration 300) appears to the user, at user interests label 420. As another example, the publisher may have the option to show sponsored brands of certain topics or categories or not, at selection 430. The publisher may then be able to view a sample display.

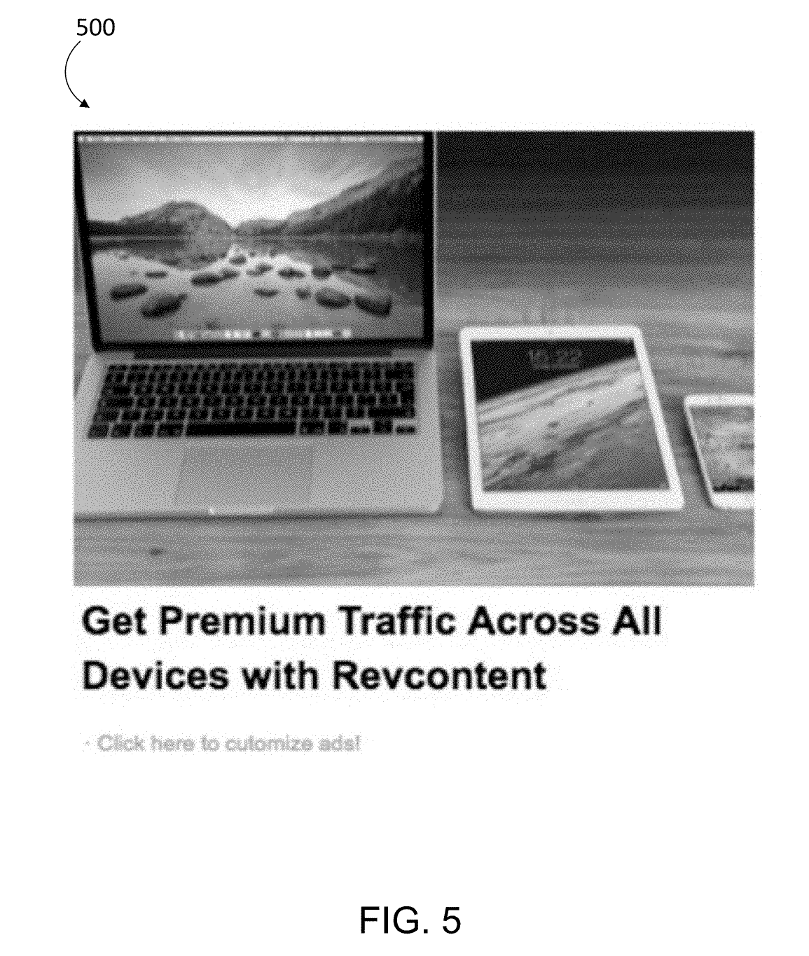

Referring to FIG. 5, illustration 500 is a sample advertisement that may prompt a user to interface with the network-based system 105, according to some embodiments. The functionality by the network-based system 105 may allow a user to customize ads toward their preferences for multiple devices, using interfaces including touch inputs and traditional desktop browsing.

In some embodiments, additional features of the interest based widget are included. A user interest-based widget differs from a normal content recommendation widget in a number ways. A traditional content recommendation is most likely based on some combination of bids and likelihood of the user to click, which results in a predictive calculation of CTR (Click-through Rate) and the end calculation is likely ECPM (Estimated Cost Per 1000 Impressions). Predicting what a user will click based off of trends and lookalike users is a common approach to the content recommendation problem. There are many signals a content recommendation platform could use to predict the likelihood of a click for a user or group of users. Where a user interest-based widget really differs is that it allows the user to upfront define interests based on a custom open or closed taxonomy. This upfront input functionality allows the content recommendation network to get a “jumpstart” on creating an interest graph for a individual user and fuels the subsequent content recommendations. The recommendation provider may also infer the user's interests by looking at various signals including web history, content consumption patterns, social network behavior, etc., to then influence the resulting recommendations. The formulation of content recommendation favors the user's interest more than bidding or predictive CTR, which in turn may have positive overall effects for the content recommendation company. Building user interest graphs at scale is not a small task, for each web session the user is identified using a unique user identifier (UUID), if the user has never been seen before this UUID is generated and assigned. This user is then created within the content recommendation networks data store. This user may also be prompted to login, this approach is favored over cookie based or client side storage techniques, as it will capture the users UUID across devices. When the user chooses their interests, browses websites with interest-based widgets, has referrer URLs on these sites, or clicks links offered by the content recommendation network, data is stored associated with the UUID. The end result is a user interest graph data store. The structure of this data store, according to some embodiments, is a weighted taxonomy where, as the user consumes data or directly tells the recommendation platform they are interested in the selected data, a weighted score is assigned to the entities defined in a taxonomy. Every URL the user visits has a set of entities, and by browsing this page it shows the user is interested in these entities and as a result augments their weighted score for such entities. A very intentional change of score for an entities is when a user directly expresses their interest by selecting them as part of utilizing the user interest-based widget.

The resulting data store is a collection of weighted entities with an additional time decay algorithm such that the content recommendation platformcan keep track of current interests versus the user's fundamental “core” interests (which may be determined at least in part by selections from the interest-based widget). When a user does not have any past data associated with their UUID, the content recommendation platform may base the user's initial interest off of lookalike data for users that have a) consumed the same current URL the widget is on, b) came from the same referrer URL as the user, and/or C) have common interests with users that have consumed content of the publisher, also known as a publisher graph. The publisher graph is a grouping of user interests for people that consume content of a site.

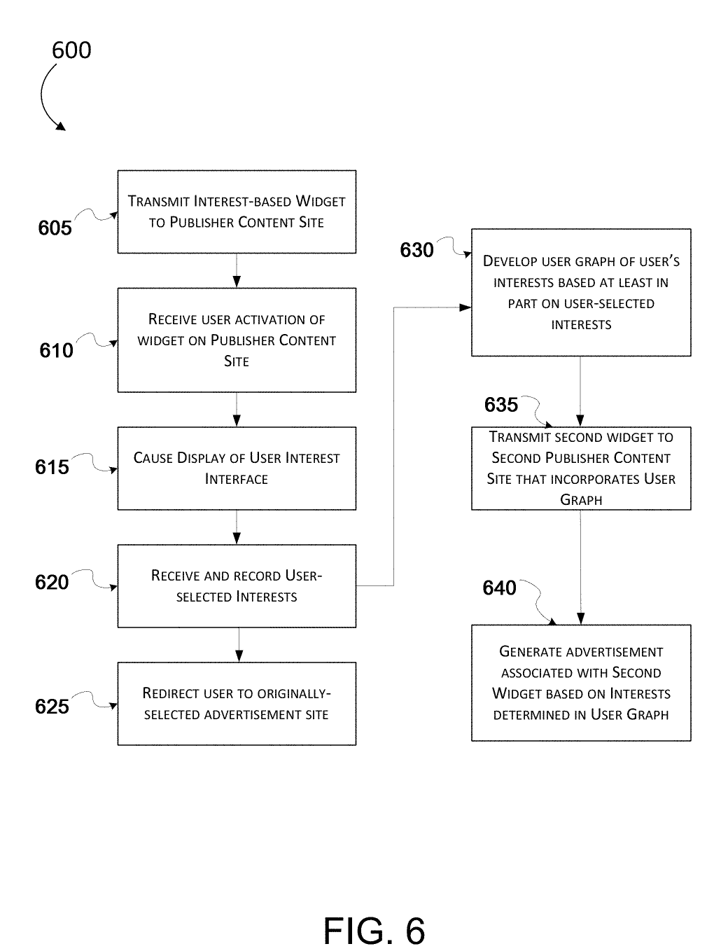

Referring to FIG. 6, flowchart 600 provides an example process for conducting the user-specified advertisement modifications, according to some embodiments. This process may be consistent with the descriptions in FIGS. 1-5. The process may be implemented by a system of the third party content recommendation network, such as the network-based system 105, for example.

At block 605, the process may begin by the network-based system 105 transmitting an interest-based widget to a content site of a publisher, according to some embodiments. The interest-based widget may include functionality for displaying a user interest interface to allow a user of the content site to specify one or more interests in types of advertisements. An example of this interface is described in FIG. 3. The interest-based widget may also include an advertisement and a link to an advertiser's website associated with the advertisement, consistent with conventional content recommendation network widgets. An example of the interest-based widget is described in FIG. 2. The interest-based widget may be embedded into a location on the content site, where the advertisement may then be displayed.

At block 610, the network-based system may receive a user activation of the interest-based widget on the publisher content site. Activation in this case means that the functionality of the interest-based widget is activated, such as the user interest interface and eventually the link to the publisher content site. This activation may occur through some user input, such as the user clicking on the advertisement of the widget that is displayed in the publisher content site, or the user hovering a cursor over the advertisement. Other types of enabling of the widget known to those with skill in the art are contemplated by the present disclosures, and embodiments are not so limited.

Once the user has activated the widget, the network-based system 105 may cause display of the user interest interface to prompt the user for one more selections of topics or categories of types of interests for later advertisements, at block 615. The network-based system 105 may not directly initiate the display, but may provide code embedded into the widget that launches upon receiving the user activation input. This code may be stored in the widget or at another convenient local storage in the user's computer. The user interest interface may have various pictures, text, and input fields for the user to view, such as those provided in FIG. 3, for example. Other types of interfaces consistent with these principles and readily ascertainable to those with skill in the art are contemplated within these disclosures, and embodiments are not so limited.

At block 620, the network-based system 105 may receive and record input for one or more user-selected interests through the user interest interface, according to some embodiments. The selection(s) may be received and stored in storage of the network-based system 105, such as in database 115. In some embodiments, the selection(s) may also or alternatively be stored locally in the user's computer, such as in one or more cookies.

When another widget associated with the network-based system 105 is loaded onto the user's computer, either in the same publisher content site or another content site, said widget may have code to look for any stored user-selected interest(s) and may utilize that information to determine what kind of advertisement(s) to display for said widget. In other cases, the stored user-selected interest(s) in the network-based system 105 may be used to determine what kind of advertisement to load and display in the widget, before the widget is loaded and embedded into the publisher site. In either case, determining what kind of advertisement may be based further on the aggregated data that makes up the interest graph.

From here, at block 625, the interest-based widget may proceed to redirect the user to the originally selected site associated with the advertisement originally displayed in the widget. In the first iteration of receiving the user-selected interest(s), the first advertisement will not be based on the user-selected interest(s) because those interests would not yet have been received before the advertisement needed to be displayed. However, later iterations may incorporate this information. Thus, the advertisement in block 625 may operate like conventional means for displaying advertisement information to the user.

At block 630, the network-based system 105 may incorporate the user-selected interest(s) into making more accurate advertisement recommendations by developing a user graph of the user's interests based at least in part on the user-selected interest(s). The user graph may include a multi-dimensional array of information describing what topics the user prefers, based on a number of factors including not just the user-selected interest(s). These factors may include previous content sites the user has visited, frequency and duration of visits, search history, purchase history, geographic location, statistical data based on demographic information of the user, and so forth. These factors may be weighted in particular ways to emphasize certain factors as being more important than others. Because there may be multiple interests of the user, but only one advertisement may be displayed per widget, a stochastic element may be incorporated into the user graph or applied after the user graph when determining the single advertisement to display to the user for that widget. The stochastic element may help to randomize the multiple interests determined for the user.

In some cases, the interest-based selection(s) may be stored to compare against other options in a taxonomy that enumerates multiple interest categories. This input may be used to generate a user interest graph that incorporates other types of data, such as web history (where in some cases the web history is time weighted for recency), content consumption patterns, social network behavior, and other choices determinable through the digital device. In some cases, the interest graph may include weighted variables, such that certain factors are given more emphasis than others. In some cases, the interest graph may also include a time decay component, where certain factors have more value only if obtained more recently in time, while other factors reflect more fundamental or “core” interests, such as the user-based interest selection. In this variation, the computation for determining advertisements utilizes the fundamental or “core” interests as a baseline, and deviates from that to some weighted degree based on the more recently obtained factors. In some cases, the user selection and the interest graph may be associated with a unique user ID, such that the data may be aggregated across multiple devices and applied to multiple devices.

At block 635, the network-based system may then transmit a second widget to a second publisher content site that incorporates the user graph and the associated inputs provided therein, according to some embodiments. This step may occur at a later point in time, when the user visits the same or another content site of a publisher associated with the network-based system 105. In general, any and all later widgets associated with the network-based system 105 may incorporate the information gleaned from the user-selected interests established by the interest-based widget at the beginning of this process.

At block 640, one full iteration of this process may complete by the network-based system 105 generating an advertisement associated with the second widget based on the interests determined in the user graph, which is ultimately based in part by the user-selected interest(s), according to some embodiments. These later generated advertisements are anticipated to better attract the user's business and attention, due to providing advertisements that are more in line with the user's expressed interests.

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine 110 or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 2-6. The instructions 724 may also reside, completely or at least partially, within the main memory 704, within the processor 702 (e.g., within the processor's cache memory), or both, before or during execution thereof by the machine 700. The instructions 724 may also reside in the static memory 706.

Accordingly, the main memory 704 and the processor 702 may be considered machine-readable media 722 (e.g., tangible and non-transitory machine-readable media). The instructions 724 may be transmitted or received over a network 726 via the network interface device 720. For example, the network interface device 720 may communicate the instructions 724 using any one or more transfer protocols (e.g., HTTP). The machine 700 may also represent example means for performing any of the functions described herein, including the processes described in FIGS. 2-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database 115, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device such as machines 110, 130, or 140 as well as cloud-based storage systems or storage networks that include multiple storage apparatus or devices such as machines 110, 130, or 140. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 722 is non-transitory in that it does not embody a propagating signal. However, labeling the tangible machine-readable medium 722 as “non-transitory” should not be construed to mean that the medium is incapable of movement; the medium should be considered as being transportable from one physical location to another. Additionally, since the machine-readable medium 722 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 726 (e.g., the Internet) and via one or more appropriate interfaces (e.g., an API).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method comprising:
transmitting, by a processor of a third party content recommendation platform, an interest-based widget to a publisher content site associated with the third party content recommendation platform, the interest-based widget comprising: information associated with an advertisement of an advertiser, a link to an advertisement site associated with the advertisement, and a link to a user interest interface;
causing display of the user interest interface, based on receiving a user input of a user of the publisher content site, through the interest-based widget embedded in the publisher content site;
receiving, by the processor, a user-selected input specifying one or more topics of advertisements the user prefers to view, through the user interest interface;
recording, by the processor, the user-selected input;
transmitting a second widget to a second publisher content site that incorporates the user-selected input; and
causing display of a second advertisement associated with the second widget that is based at least in part on the user-selected input.

2. The method of claim 1, further comprising redirecting the user to an originally selected advertisement site of the interest-based widget.

3. The method of claim 1, further comprising developing a user graph comprising a determination of the user's advertising interests, based at least in part on the user-selected input.

4. The method of claim 3, wherein transmitting the second widget to the second publisher is based on the developed user graph.

5. The method of claim 3, wherein developing the user graph comprises developing a fundamental core set of user interests, based on the user-selected input, and developing a time-decay set of user interests that loses weight in determining the interests in the user graph as time passes.

6. A system for a third party content recommendation platform, the system comprising:
a server comprising a processor and a memory coupled to the processor;
the processor configured to:
transmit an interest-based widget to a publisher content site associated with the third party content recommendation platform, the interest-based widget comprising: information associated with an advertisement of an advertiser, a link to an advertisement site associated with the advertisement, and a link to a user interest interface;
cause display of the user interest interface, based on receiving a user input of a user of the publisher content site, through the interest-based widget embedded in the publisher content site;
receive a user-selected input specifying one or more topics of advertisements the user prefers to view, through the user interest interface;
record by the processor, the user-selected input;
transmit a second widget to a second publisher content site that incorporates the user-selected input; and
cause display of a second advertisement associated with the second widget that is based at least in part on the user-selected input.

7. The system of claim 6, wherein the processor is further configured to redirect the user to an originally selected advertisement site of the interest-based widget.

8. The system of claim 6, wherein the processor is further configured to develop a user graph comprising a determination of the user's advertising interests, based at least in part on the user-selected input.

9. The system of claim 8, wherein transmitting the second widget to the second publisher is based on the developed user graph.

10. The system of claim 8, wherein developing the user graph comprises developing a fundamental core set of user interests, based on the user-selected input, and developing a time-decay set of user interests that loses weight in determining the interests in the user graph as time passes.

11. A non transitory computer readable medium comprising instructions that, when interpreted by a processor, cause a machine to perform operations comprising:
transmitting an interest-based widget to a publisher content site associated with a third party content recommendation platform, the interest-based widget comprising:
information associated with an advertisement of an advertiser, a link to an advertisement site associated with the advertisement, and a link to a user interest interface;
causing display of the user interest interface, based on receiving a user input of a user of the publisher content site, through the interest-based widget embedded in the publisher content site;
receiving a user-selected input specifying one or more topics of advertisements the user prefers to view, through the user interest interface;
recording the user-selected input;
transmitting a second widget to a second publisher content site that incorporates the user-selected input; and
causing display of a second advertisement associated with the second widget that is based at least in part on the user-selected input.

12. The non transitory computer readable medium of claim 11, wherein the instructions further comprise redirecting the user to an originally selected advertisement site of the interest-based widget.

13. The non transitory computer readable medium of claim 11, wherein the instructions further comprise developing a user graph comprising a determination of the user's advertising interests, based at least in part on the user-selected input.

14. The non transitory computer readable medium of claim 13, wherein transmitting the second widget to the second publisher is based on the developed user graph.

15. The non transitory computer readable medium of claim 13, wherein developing the user graph comprises developing a fundamental core set of user interests, based on the user-selected input, and developing a time-decay set of user interests that loses weight in determining the interests in the user graph as time passes.
